(19) United States
(12) Patent Application Publication
(10) Pub. No.: US 2017/0066018 A1
(43) Pub. Date: Mar. 9, 2017

(54) A MODULAR SIEVING BOX

(71) Applicant: YUKSELIS MAKINA SANAYI VE TICARET ANONIM SIRKETI, Eskisehir (TR)

(72) Inventor: Sedat KUNDURACI, Eskisehir (TR)

(73) Assignee: YUKSELIS MAKINA SANAYIVE TICARET ANONIM SIRKETI, Eskisehir (TR)

(21) Appl. No.: 15/119,822

(22) PCT Filed: Feb. 18, 2014
(86) PCT No.: PCT/TR2014/000046

§ 371 Date: Aug. 18, 2016

(51) Int. Cl. B07B 1/52; B07B 1/46

(52) U.S. Cl. CPC B07B 1/522; B07B 1/4618

(57) ABSTRACT

For use in sieving machines where pluralities of products are classified by sieving, a sieving box is provided having at least one sieve frame having edge profiles whereon a sieve is fixed and having a brush pan with a brush movement surface and at least one product passage opening. At least one support frame is provided having at least one output module having at least one module passage opening in a manner matching with the product passage opening provided on the brush pan and at least one closing rod by being positioned between the sieve frame and at least one brush pan obtained by bending at least one bendable plate from the bending lines.

### TECHNICAL FIELD

The present invention relates to a sieving box for providing classification of foodstuff like cereal, by being sieved, in sieving machines.

### PRIOR ART

In the present art, sieving boxes are obtained by joining pieces made of wooden or plastic type materials. Said joining process is realized by means of adhering, nailing and similar methods. In another alternative production method, sieving boxes are formed by means of pouring plastic-derived materials into the molds or by pressing by means of injection method.

In the application with reference number WO2012/131500, there is a bottom base box and an upper box positioned on said bottom base box in order to form the sieving box. Said upper box is mono-block with the product passage opening, and has the same size as the outer dimensions of the frame. Thus, it is strained and is used in a manner covering the product passage opening together with the box straining allowances to be joined to the upper frame, and leads to important amount of loss. Moreover, the production of the upper box comprising profiles with different cross sections and thicknesses is difficult and has a high cost. A plate is assembled onto the bottom base box and the brush working surface is formed. The form deteriorations which may occur on said plate lead to tightening and malfunctioning of the brushes positioned in between. For this reason, placing a support to the plate will bring an additional cost, and leads to height and volume loss in the bottom box of the sieving box.

In the application with reference number EP1268032, a sieving plate is disclosed which is obtained by bending the sheet plate in one-piece form. Support portions are formed by cutting said sheet plate and by bending only from two mutual edges and sieving plates in ‘U’ form which may have pluralities of product passing openings thereon are obtained.

Said sieving plate, which is obtained by means of bending, functions as a sieve together with the holes formed on the sieving plate. Accordingly, in said embodiment, the usage of a brush is not possible. As a result, because of all of the abovementioned problems, an improvement is required in the related technical field.

### BRIEF DESCRIPTION OF THE INVENTION

The present invention relates to a sieving box for sieving machines, for eliminating the above mentioned disadvantages and for bringing new advantages to the related technical field.

The main object of the present invention is to provide a sieving box whose production is facilitated and at the same time whose resistance is increased.

Another object of the present invention is to provide a sieving box providing the product output direction to be changed in the desired manner.

Another object of the present invention is to provide a sieving box whose cost is reduced.

In order to realize all of the abovementioned objects and the objects which are to be deducted from the detailed description below, the present invention is for use in sieving machines where pluralities of products are classified by being sieved;

and the present invention is a sieving box having at least one sieve frame having edge profiles and whereon a sieve is stretched and having a brush pan comprising a brush movement surface on which at least a brush is moved and comprising at least one product passage opening. Accordingly, said sieving box comprising at least an output module having at least a module passage opening in a manner matching with product passage opening provided on brush pan, by being positioned between said sieve frame and at least one brush pan obtained by bending at least one bendable plate from the bending lines, Thus, in the modular structure formed, the items forming the box support element are produced in a separate manner and thus, a structure whose resistance is increased and whose cost is decreased is obtained.

On the other hand, since the output module is a separate element, the sieve frame is provided in smaller dimensions, and the wastes formed while a sieve is strained thereon are eliminated.

In a preferred embodiment of the subject matter invention, the brush pan comprises at least one under-frame pressing surface obtained by bending the bendable plate from at least one bottom rim bending line.

In another preferred embodiment of the subject matter invention, the brush pan comprises at least one frame corner chamfer obtained by bending the bendable plate from at least one corner chamfer bending line.

In another preferred embodiment of the subject matter invention, at least one modular guiding rod is provided whereon at least one other edge profile is seated.

In another preferred embodiment of the subject matter invention, said support frame comprises at least one support rod extending in a manner supporting the intermediate profiles of the sieve frame. Thus, since the intermediate profiles are supported by the support rods, the gap between the sieve frame and the brush pan is kept fixed and the stuck of the brush because of probable shape deteriorations is prevented.

In another preferred embodiment of the subject matter invention, said output module comprises at least one connection extension whereon at least one edge profile of the sieve frame is seated.

In another preferred embodiment of the subject matter invention, at least one support rod is provided extending in a manner supporting said intermediate profiles.

In another preferred embodiment of the subject matter invention, said output module comprises at least one module body whereon said module passage opening is provided and having a module body height which is greater than the connection extension height of the connection extension.

In another preferred embodiment of the subject matter invention, the connection extension height is equal to the support rod height of the support rod.

In another preferred embodiment of the subject matter invention, the sum of sieve frame height of the sieve frame and of the connection extension height is essentially equal to the height of the module body.

In another preferred embodiment of the subject matter invention, contains at least one assembly hole to provide support rod to be screwed over the brush pan.

In another preferred embodiment of the subject matter invention, the support rod, the modular guiding rod, the closing rod and the output module forming the support frame are removable in an independent manner from each other. Thus, by changing the positions of said items, the products can be guided to different directions.

In another preferred embodiment of the subject matter invention, the support rod, the closing rod and the modular guiding rod are made of plastic based material.

In another preferred embodiment of the subject matter invention, output module is made of plastic based material.

### BRIEF DESCRIPTION OF THE FIGURES

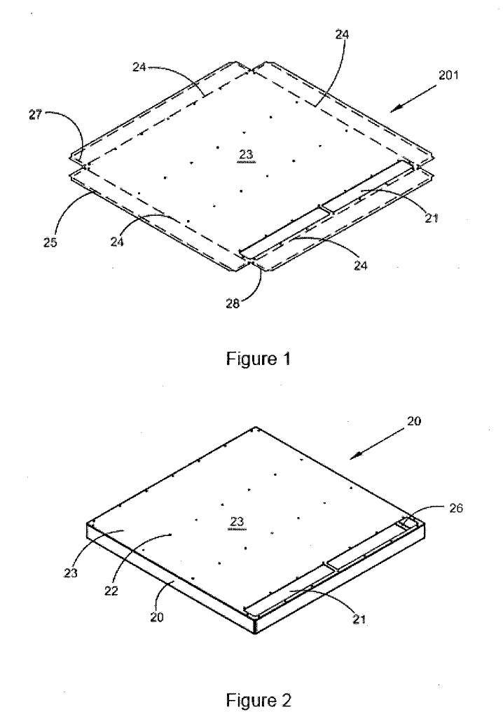

In FIG. 1, a representative view of the cut form of the subject matter sieving box before the brush pan is bent is given.

In FIG. 2, a representative view of the bent form of the brush pan of the subject matter sieving box is given.

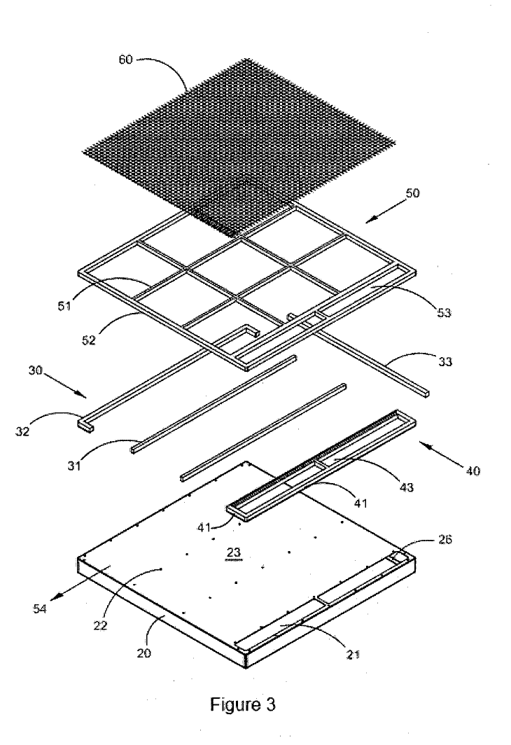

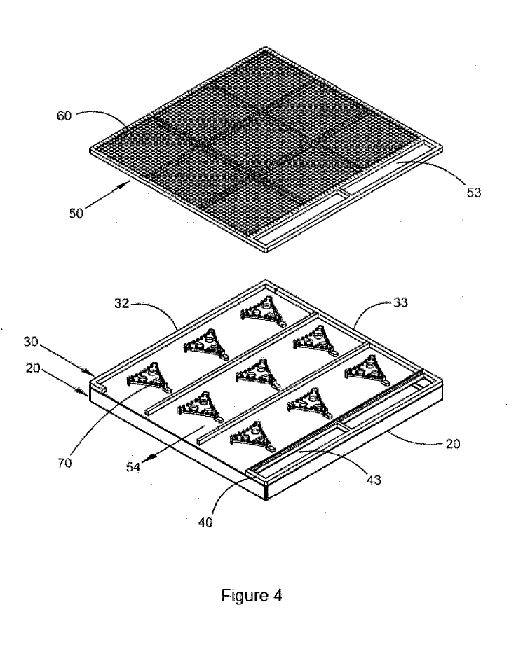

In FIG. 3, a dismantled view of the integrated position of the output module and of the sieving box of the subject matter sieving box is given.

In FIG. 4, a representative view is given illustrating the assembled form of the modular support frame of the subject matter sieving box to the bending brush pan.

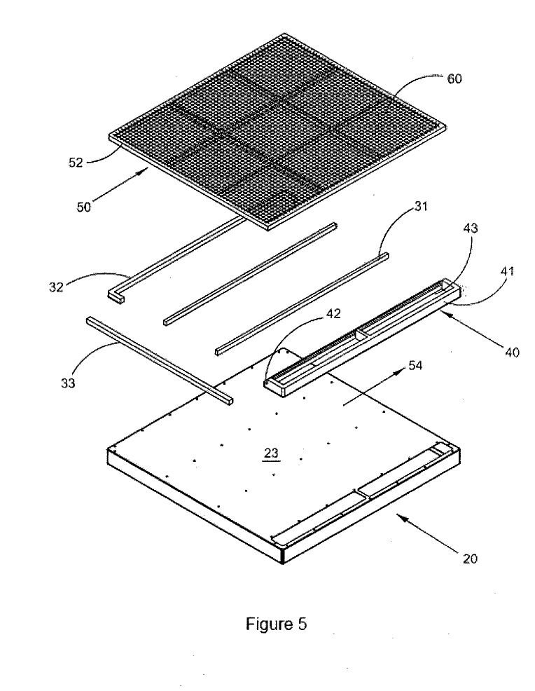

In FIG. 5, a dismantled view is given illustrating the output module of the subject matter sieving box which is zoomed up to the upper portion of the sieve frame.

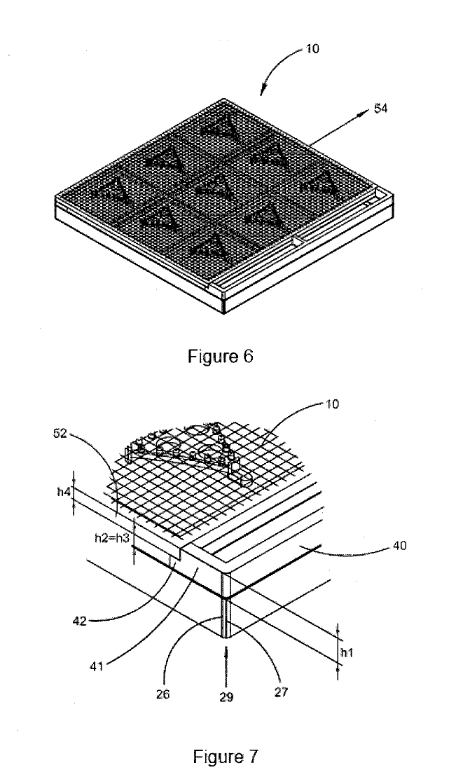

In FIG. 6, a view is given illustrating the completely assembled form of the subject matter sieving box together with the brushes and the sieve thereof.

In FIG. 7, a detailed zoomed view of a corner of the subject matter sieving box is given.

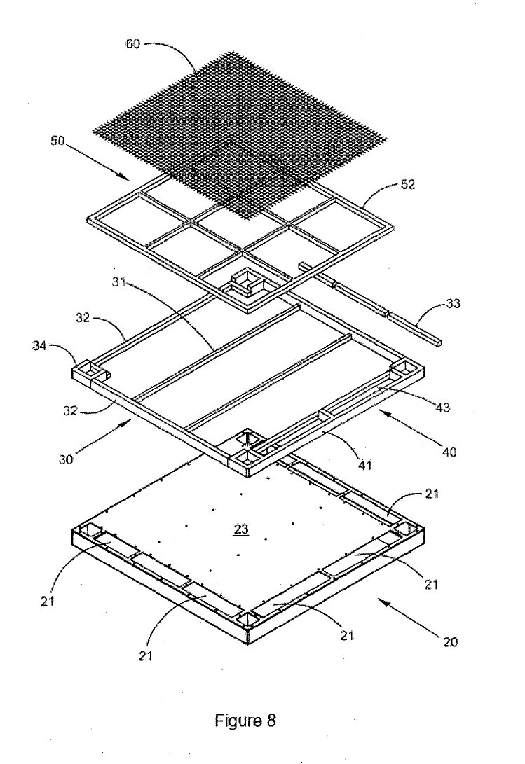

In FIG. 8, a dismantled view of an alternative embodiment of the subject matter sieving box where the product outputs thereof are passed through the frame is given.

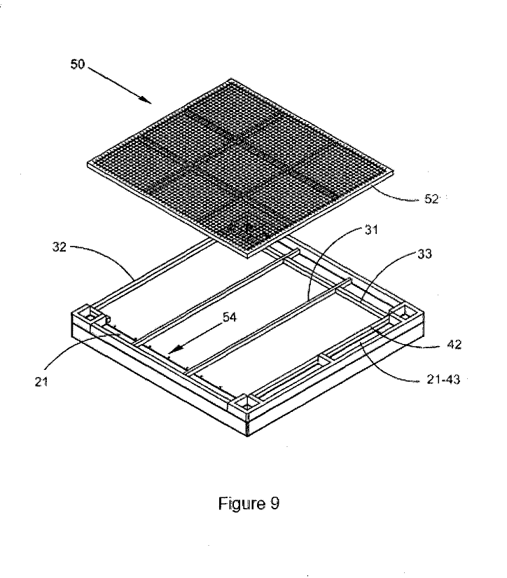

In FIG. 9, another representative dismantled view of an alternative embodiment of the subject matter sieving box is given.

### REFERENCE NUMBERS

10 Sieving box
20 Brush pan
201 Bendable plate
   21 Product passage opening
   22 Assembly holes
   23 Brush movement surface
   24 Bending line
   25 Bottom rim bending line
   26 Under box pressing surface
   27 Corner chamfer bending line
   28 Corner joining edge
   29 Box corner chamfer
30 Support frame
   31 Support rod
   32 Closing rod
   33 Modular guiding rod
   34 Corner module
40 Output module
   41 Module body
   42 Connection extension
   43 Module passage opening
50 Sieve frame
   51 Intermediate profile
   52 Edge profile
   53 Frame passage opening
   54 Sieved product output direction
60 Sieve
70 Brush
h1 Module body height
h2 Connection extension height
h3 Closing-support rod height
h4 Sieve frame height

### THE DETAILED DESCRIPTION OF THE INVENTION

In this detailed description, the subject matter sieving box (10) is explained with references to examples without forming any restrictive effect in order to make the subject more understandable.

As can be seen in FIG. 2 and FIG. 6, the sieving boxes (10) provided in sieving machines used for classifying foodstuff like cereal, by being sieved, essentially comprise a brush pan (20), and a sieve frame (50) provided on said brush pan (20), and a sieve (60). Moreover, in the subject matter sieving box (10), there is a support frame (30) positioned between said brush pan (20) and the sieve frame (50) (FIG. 5)

The brush pan (20) is brought into form illustrated in FIG. 2 by means of bending and shaping of a material in the form of a bendable plate (201) illustrated in FIG. 1. Accordingly, in more details, the bendable plate (201) for forming the brush pan (20) is cut in quadrangular form and in a manner obtaining corner joining edges (28) by taking quadrangular pieces from the four corners as can be seen in FIG. 1. There are bending lines (24) at a predetermined distance at the edges of the bendable plate (201). Moreover, there is the bottom rim bending line (25) preferably determined so as to be closer to the edges between the edges and the bending lines (24). An under box pressing surface (26) is obtained between said bottom rim bending line (25) and the edge. On the brush pan (20), there is a brush movement surface (23) whereon the brushes (70) are movable, and there is at least one product passage opening (21) on said brush movement surface (23) (FIG. 2). Said product passage opening (21) is essentially provided in the form of an opening extending at the vicinity of an edge of the brush pan (20). In the alternative embodiments illustrated in FIG. 8, more than one product passage opening (21) is provided and may be formed in the vicinities of different edges. All of said cutting processes may be realized by means of presses or by means of alternative cutting methods like laser, etc.

In FIG. 7, moreover, there are corner chamfer bending lines (27) defined in vicinities of corner joining edges (28). The bendable plate (201) bending line (24), bottom rim bending line (25) and the corner chamfer bending lines (27) which may be bent for forming the brush pan (20) are brought to the form illustrated in FIG. 2 by means of bending. By means of bending process of the corner chamfer bending lines (27), box corner chamfers (29) are formed at the four sides of the brush pan (20).

In FIG. 4, the support frame (30) assembled to the brush pan (20) obtained by bending is illustrated, and the support frame (30) described in FIG. 5 is in dismantled form.

As can be seen in FIGS. 3 and 4, in the preferred embodiment of the present invention, the sieve frame (50) comprises intermediate profiles (51) providing edge profiles (52) and a cage structure so as to form a quadrangle. Accordingly, in the sieving box (10), the sieve (60) is disposed on the sieve frame (50). In the preferred embodiment of the present invention, the sieve (60) is strained and is fixed on the sieve frame (50) by means of pluralities of methods. In the alternative embodiments of the present invention, there may be frame passage openings (53) through which the product, which does not pass through the sieve, may pass as can be seen in FIG. 3. In another embodiment, there are frame passage openings (53) on the sieve frame as can be seen in FIG. 5. Thus, during straining of sieve (60), made of cloth or wire material, onto the sieve frame (50), excessive material usages and wastes are prevented.

The support frame (30) provided between the sieve frame (50) and the brush pan (20) comprises at least one closing rod (32), at least one support rod (31) extending on the brush movement surface (23), and at least one output module (40). Said support rod (31) is used for preventing bending and similar surface movements of the brush movement surface (23). Said output module (40) extends on the brush pan (20) along the edge where the product passage opening (21) is provided. Moreover, there is at least one module passage opening (43) on the output module (40).

As can be seen in FIG. 4, when the output module (40) is positioned on the brush pan (20), said module passage opening (43) corresponds to the product passage opening (21) provided on the brush pan (20). The assembly of the support frame (30) to the brush pan (20) is realized by means of the connection members through the assembly holes (22) provided on the brush pan (20). By means of said assembly method, the modular guiding rods (33) provided on the edges are removed and they can be fixed to the other edge, and thus, the guiding of the product to the other direction becomes possible. In the preferred embodiment of the present invention, at least one support rod (31) and at least one closing rod (32) extend in a parallel manner with respect to the output module (40). Preferably on one of the other two edges of the brush pan (20), a modular guiding rod (33) is provided extending in a manner preventing product output. Thus, it is left open so as to permit sieved product output in the direction of product output direction (54) from the other edge where the modular guiding rod (33) is not provided. In case the modular guiding rod (33) is not even used, the sieved product can be taken outwardly from both sides.

In FIG. 5, in the preferred embodiment of the present invention, the output module (40) comprises a module body (41), and a connection extension (42) provided on the side of said module body (41) facing the brush movement surface (23). Said connection extension (42) preferably extends along the output module (40). Accordingly, as can be seen in FIG. 7, the height (h1) of the output module (40) body is greater than the height (h2) of the connection extension. In the preferred embodiment of the present invention, the connection extension height (h2) is equal to the support rod height (h3). When the sieve frame (50) is positioned on the support frame (30), the sum of the height (h4) of the sieve frame (50) and the height (h3) of the support rod is equal to the height (h1) of the module body. As detailed in FIG. 5-6, when the sieve frame (50) is disposed on the support rod (31), an edge profile (52) of the sieve frame (50) seats onto the connection extension (42) of the output module (40).

In FIG. 8-9, an alternative embodiment of the sieving boxes (10) is given. In this alternative embodiment, the sieved product can be passed from the sieving box (10) through the product passage openings (21) formed on the vertical edges with respect to the output module (40) on the brush pan (20). Again in this embodiment, there is the modular guiding rod (33), and is assembled in a manner preventing product output in the preferred one of the two edges. Thus, the sieved product is passed through one of product passage openings (21) on the other edge of the brush pan (20) through the sieving box (10) in the direction of the product output direction (54) from the other edge where there is no modular guiding rod (33). In this application, in case the modular guiding rod (33) is not used, they are passed through product passage openings (21) on both sides in vertical position with respect to the modular guiding rod (33). Moreover, in this application, the size of the sieve frame (50) is reduced in a manner allowing product output through the edges. Because of the reduced sieve frame (50), there is a corner module (34) at the corners, and the structure of the output module (40) is changed in a manner comprising corner module (34).

In the subject'matter sieving box (10), the closing rod (32), the modular guiding rods (33), the support rods (31) and the output module (40) are embodied as separate pieces and they can also be embodied in a one-piece manner or partially one-piece manner.

In the preferred embodiment of the present invention, during formation of the sieving box (10), as can be seen in FIGS. 4 and 9, first of all, the closing rod (32) forming the support frame (30), the output module (40), the support rods (31) and the modular guiding rods (33) are fixed to the brush pan (20). Finally, the sieve frame (50) whereon the sieve (60) is provided is disposed onto the support frame (30) as can be seen in FIG. 6. During said placement, the support rods (31) are provided so as to correspond one above the other with the intermediate profiles (51) of the sieve frame (50). Thus, the distance between the sieve frame (50) and the brush movement surface (23) provided on the brush pan (20) is provided to be fixed. In other words, the brushes (70) positioned in between are prevented from becoming useless because of the probable shape change in the sieve frame (50) and the problematic surfaces on the brush pan (20).

Since the sieve frame (50) of the subject matter sieving box (10) and the pieces forming the support frame (30) are modular, each piece can be produced in a separate manner from the metal or plastic based material. Thus, during production of the one-piece structure in the prior art from plastic material, the resistance insufficiencies, formed because of regions with different thicknesses, are prevented. Moreover, in alternative embodiments, the sieve frame (50) and the support frame (30) can be made of aluminum, wooden, etc. alternative materials besides plastic. In the preferred embodiment of the present invention, the output module (40) is made of plastic based material.

Thanks to the modular structure of the subject matter sieving box (10), the production and assembly thereof are facilitated. In other words, the support rod (31), the positions and numbers of the modular guiding rod (33), the output modules (40), and the closing rod (32) forming the support frame (30) are changed, and sieving boxes (10) with different types are obtained. In this manner, the product can be guided to different directions optionally.

1. Sieving box, for use in sieving machines where pluralities of products are classified by being sieved; having;
at least one sieve frame having edge profiles whereon a sieve is fixed; and
at least one brush pan obtained by bending a bendable plate at a plurality of bending lines forming wall portions extending away from the brush movement surface, wherein the brush pan comprises a brush movement surface,
characterized in that said sieving box comprises:
said brush pan which comprises at least one product passage opening, and at least one under-box pressing surface, extending in parallel to the brush mounting surface, obtained by bending the bendable plate from the bending line and from at least one bottom rim bending line,
at least one support frame
assembled on said brush pan, and positioned between the sieve frame and the brush pan, and
having at least one closing rod and at least one output module having at least one module passage opening in a manner matching with the product passage opening provided on said brush pan.

2. A sieving box according to claim 1, characterized in that the brush pan comprises at least one box corner chamfer obtained by bending the bendable plate from at least one corner chamfer bending line.

3. A sieving box according to claim 1, characterized in that at least one modular guiding rod, which forms part of the support frame and which guides the product to be guided to different sections, is provided whereon at least one of the edge profiles is seated.

4. A sieving box according to claim 1, characterized in that said support frame comprises at least one support rod, which is part of support frame, extending in a manner supporting intermediate profiles of the sieve frame.

5. A sieving box according to claim 1, characterized in that said output module comprises at least one connection extension whereon at least one edge profile of the sieve frame is seated.

6. A sieving box according to claim 1, characterized in that said output module comprises at least one module body whereon said module passage opening is provided and having a module body height which is greater than the connection extension height of the connection extension.

7. A sieving box according to claim 4, characterized in that the connection extension height is equal to the support rod height of the support rod.

8. A sieving box according to claim 7, characterized in that the sum of sieve frame height of the sieve frame and of the connection extension height is essentially equal to the height of the module body.

9. A sieving box according to claim 3, characterized in that the support rod, the modular guiding rod, the closing rod, and the output module forming the support frame are removable in an independent manner from each other.

10. A sieving box according to claim 3, characterized in that the support rod, the closing rod, the modular guiding rod and the output module are made of plastic based material.

11. A sieving box according to claim 4, characterized in that the support rod, the modular guiding rod, the closing rod, and the output module forming the support frame are removable in an independent manner from each other.

12. A sieving box according to claim 4, characterized in that the support rod, the closing rod, the modular guiding rod and the output module are made of plastic based material.
